(19) United States
(12) Patent Application Publication
(10) Pub. No.: US 2019/0325632 A1
(43) Pub. Date: Oct. 24, 2019

(54) System and Method for Digital Persona Personality Platform

(71) Applicant: Charles Rinker, Wake Forest, NC (US)

(72) Inventor: Charles Rinker, Wake Forest, NC (US)

(21) Appl. No.: 15/959,001

(22) Filed: Apr. 20, 2018

(51) Int. Cl. G06T 13/40; G06T 13/20; G06T 19/20; H04L 29/08

(52) U.S. Cl. CPC G06T 13/40; H04L 67/306; G06T 19/20; G06T 13/205

(57) ABSTRACT

This document presents an apparatus and method for a digital persona platform that interacts with users to create personas, personalities, and character scenes that include the created personas and personalities for display and interaction with users. The digital persona platform stores computer generated characters and scenes in which the characters are optimized for interaction with human users. The digital persona platform provides for display of characters on systems having holographic, augmented reality, virtual reality, mobile device, and multiple platform display capability. Characters and character scenes created on the digital persona platform may be stored and recalled for later use.

### COPYRIGHT NOTICE

A portion of the disclosure of this patent document contains material that is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Computer generated characters are a standby of films, cartoons, movies, and other interactive video displays. Renderings of such computer-generated characters may be seen on computer, television, mobile device, and other screens, but holographic, three dimensional characters are not as freely available due to the more expensive equipment required to display a three dimensional character.

Holographic projectors and display systems exist that permit the creation and display of three-dimensional characters. However, the creation of such characters often requires a fully equipped video production studio each time a change or generation of a new character is necessary. Additionally, the display requirements of a holographic system often require a large space to accommodate the projection equipment. Communication may be enhanced using such three-dimensional interactive video displays.

Likewise, automated attendants having a lifelike appearance are infrequent due to the complexity of the display equipment required to create and render such attendant images. Interactive systems have been attempted on occasion with little long-term success, although such lifelike, interactive systems would be useful in many situations where such an automated attendant may enhance physical communication.

Lifelike personalities generated for digital characters often require patterning after an existing human subject in addition to programming characteristics and tweaking the personality generated. The tweaking is generally performed by one or more teams of individuals who interact with the code generated personality and update the personality to interact in a more “human” fashion. Automatic generation of personalities for digital personas is a complex and time-consuming activity.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a perspective view of the platform implementation user experience (UX) consistent with certain embodiments of the present invention.

FIG. 2 is a view of functions incorporated within and controlled by the personality profile platform component consistent with certain embodiments of the present invention.

FIG. 3 is a view of functions incorporated within and controlled by the design factory platform component consistent with certain embodiments of the present invention.

FIG. 4 is a view of functions incorporated within and controlled by the personality engine platform component consistent with certain embodiments of the present invention.

FIG. 5 is a view of functions incorporated within and controlled by the experience engine cross-platform component consistent with certain embodiments of the present invention.

FIG. 6 is a view of the human experience (UX) display platform component consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “motion communication system” or similar terms means a visual system of communication where gestures and motion are used to convey meaning to foster communication between one person and another person, between one person and a group of people, or between groups of people. In this communication system the gestures and motions may be recorded, computer generated, generated using a video capture system, or any combination of recording, video capture and computer generation.

Reference throughout this document to “ASL” refers to American Sign Language.

Reference throughout this document to “sign language” refers to any standardized system of sign language gestures and motions that have been codified into a labeled sign language. Some examples of these are American Sign Language, British Sign Language, Australian Sign Language, and any of the more than 130 other standardized sign language implementations currently recognized.

In an embodiment, the digital persona platform leverages advanced computer-generated characters to create flexible, photo realistic human and non-human character representations that offer several advantages of video and other media. Advanced computer-generated characters (CGCs) permit complete cosmetic customization based on client requirements including hair color, eye color, skin color, wardrobe, etc., and an ability for single computer generated character (CGC) to speak literally any language and the ability to change at will simply by updating the spoken voice. Remote content updates are possible without requiring any updates to the physical structure of the PRSONAS unit, and there is no need for expensive (or repeated) video productions to capture initial messaging or to update existing messaging.

In an embodiment, this document discloses a digital persona platform that allows for the authoring, interpreting and “play back” of a digital personality as represented by one or more CGCs. The platform may consist of a component that builds a personality profile, a design factory component to permit the creation of design elements for a CGC, a personality engine that permits the creation and editing of personalities for each CGC, and an experience engine to monitor, manage and control the elements of the system. Within this platform, the Design Factory consists of an authoring environment where creative personnel can design a digital personality. The digital personality is associated as the personality that may be assigned to a CGC. Through a complex user interface, a user can initiate the creation of, and add, delete, and/or manipulate all the traits of the digital personality. The traits of the digital personality may include aesthetics (how it looks), the digital personality's domain expertise (what its knowledge base is), how the digital personality responds (scripts and personality traits), the languages in which the digital personality communicates (spoken and sign-based languages) and how the digital personality is animated. As the user drafts and generates these pieces of information, they are stored within the Personality Profile, a relational database structure created and maintained for personality profile data, for use by the other modules of the PRSONAS Personality Platform.

In an embodiment, the Design Factory component of the system platform may include the capability for a user to create a customized User eXperience (UX) interface for communication with the platform. The UX design may enable the designer to define and establish elements of the overall UX design as a customized, self-directed UX component. The customized self-service UX design to create specific elements for inclusion in the customized UX design.

In an embodiment, the digital persona platform may also contain a Personality Engine. The Personality Engine consists of one or more modules that may import all of the information contained in the PERSONALITY PROFILE and create the appropriate response actions based upon that information. Response actions may include what a CGC will say, how the CGC will say it, define the language in which responses are made and provide for the support actions to be performed by the CGC to properly animate the character. These support actions may include facial animation, secondary animation or even triggering other content from other systems, including, in one or more non-limiting examples, sending SMS messages, e-mail, playing a video or any other 3^{rd} party integration.

In an embodiment, personality profile has a proprietary data structure that contains all the information required to create a “digital personality”, also known as a persona. The data required to create a digital personality may include, but is not limited to aesthetic information, domain expertise, personality parameters, character movement, character voice and character language(s). In a non-limiting example, the aesthetic information may include definition on what the character is, for example, male, female, human, alien or any object we can define with which a personality may be associated such as a talking animal or even abstract talking devices (such as a refrigerator, table, etc.). The aesthetic information will vary based on the personality and/or character selected, but may typically contain information such as hair style and color, eyes, physical body characteristics, what type of clothes, branding, colors, or any other information that may define how the personality is visualized by users and observers of the personality.

In an embodiment, the digital persona platform may also contain an experience engine. The experience engine is the playback mechanism through which people will see and interact with the digital personality expressed during execution of a display experience. The experience engine is built as a cross-platform implementation so that the digital persona platform may take the responses generated from the personality engine and play the responses back as appropriate for the device. The experience engine also will take any environmental input, such as, in non-limiting examples, speech, touch screen clicks, external sensors or any other online or directly sensed information, as well as other inputs created and transmitted by third-party data providers and relay it back to the personality profile module which will communicate all received environmental input to the personality engine. The experience to the user may be, but is not limited to, a physical projection or playback screen, a virtual reality, augmented reality, other mixed reality display or even new display technologies not yet commonplace. This experience engine permits the expansion of deployment channels through interaction and integration with outside systems and third party providers without impacting the digital personality created by the digital persona platform.

### Data Structures:

In an embodiment, the digital persona platform stores and manages a plurality of data structures that may be utilized in execution and operation of a CGC when required. A data structure is associated with the Personality Profile—This is a proprietary data structure, called the Personality Profile, that contains all the information required to create a “digital personality”. This profile information can then be authorized, interpreted and “played back” on any part of the digital persona platform or even through integrations with other 3^{rd} party developer applications and tools.

In an embodiment, the Personality Engine encompasses a series of algorithms to interpret all the Personality Profile characteristics and translates them into a native data format that can be leveraged and “played back” by the Experience Engine. This normalization of data to a native data format creates a “universal translator” in that the algorithms, once applied, demonstrates that all parameters currently defined in the Personality Profile may be translated into the native data format. The digital persona platform also contains a tool for defining and authoring the personality parameters and the overall experience.

In an embodiment, the digital persona platform may also contain a cross platform experience engine that may permit all defined and captured experiences to be played back over multiple devices. This is entirely unlike creating a “cross platform” game engine that allows one piece of game code to be played across Xbox, Playstation, PC, Windows, etc. from a single code base. The Personality Engine will handle the translations that are specific to each digital personality and regulates what data formats will be needed by the experience playback engine to deliver the full User Experience.

In an exemplary embodiment, a digital persona platform CGC is created through a multistep pipeline process. In addition to the multistep pipeline process of character creation, the system also keeps the silhouette of the CGC fixed to permit the character to remain centered in the silhouette. Remaining centered in the silhouette retains an illusion of a character having mass within the silhouette. This silhouette cutout provides a “hologram” effect instead of simply a “rear projection” because the cutout provides for a visual three-dimensional appearance of the character being displayed within the silhouette.

The system also maintains “lighting masks” and “color masks” to keep an even light and even color when being projected in an ultra-short throw holographic projection system, as used in this system. Lighting masks and color masks assist in correcting lighting and color settings insuring that the display of the CGC presented in the silhouette is properly balanced with no fading and color tones that are rendered without distortion or off-color from the selected color palette for the particular character being displayed.

The delivery of the CGC imagery into the physical world utilizes the hardware integration between the display hardware setup and the ‘character scene.’ The ‘character scene’ derived from the creation process is fed into 3Dimensional (3D) real-time rendering software running on a CPU/render hardware. The render hardware sends a digital video output to the display apparatus, where the display apparatus may be a holographic projector contained in a system chassis, may be an active scene component displayed as a part of a virtual reality projection, may be an augmented reality segment, may be a display optimized for presentation on a mobile device, or may be a component of a future display system. The character scene will be optimized for the display system to which the CGC and whole scene will be delivered and displayed.

In an embodiment, an extension of the use of a computer-generated character is the ability of the CGC to produce physical hand and arm positions that are used in a motion communication system such as a sign language when presented in any display system. In use in the United States, American Sign Language (ASL), may be produced by a 3D, holographic CGC due to the ability to produce signs that form ASL concepts in three dimensions. This capability permits an advanced CGC to serve as an automated attendant, perform in a docent role, permit the translation from standard spoken United States languages into ASL for real time or pre-recorded speeches, or provide information in ASL to the hearing impaired in any public forum such as schools, churches, hospitals, or other public buildings.

The digital persona platform may include a motion communication component to provide for motion-based language usage. However, the motion communication component is not restricted to a computer-generated character providing communication in ASL. Due to the nature of motion capture and generation capabilities of current computer systems, any defined or known sign language may also be presented by a computer-generated character. Additionally, the system may be designed to provide language translation and communication utilizing human-like or non-human-like characters by creating the positions and motions required for the physical language signs in a 3-dimensional view space and directing the computer-generated character to form those positions and motions when in operation regardless of the type of display system to which the CGC and/or character scene are delivered.

In this embodiment, the CGC creation software module maps signs, gestures, and facial video sequences into a three-dimensional CGC completed image. The CGC creation software module creates a three-dimensional digital video output for projection onto the display silhouette device to provide communication to viewers who are hearing challenged and those who hear normally. The signs and gestures that form communication through the structure of one or more defined sign languages are presented visually by the CGC. In an alternative embodiment, the visual representation for the communication in sign language may be presented by a CGC while simultaneously presenting the same communication in an audible form.

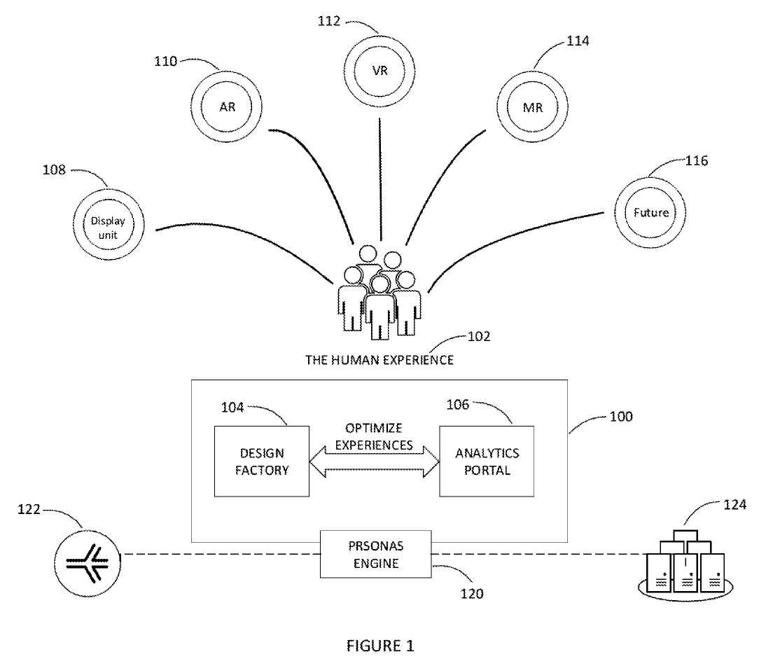

Turning now to FIG. 1, this figure presents a perspective view of the platform implementation user experience (UX) consistent with certain embodiments of the present invention. In an exemplary embodiment, the digital persona platform 100 provides the ability to create a UX 102 that may be exported to several different display and interaction formats and devices. The digital persona platform 100 includes a design factory 104 component as well as an analytics portal 106 having a full two-way data exchange pathway that permits the digital persona platform 100 to create optimized experiences based upon incoming data and instructions from users and the design factory 104. User interaction data is imported from sensors through the analytics portal 106 and stored within data structures maintained by the digital persona platform 100. The digital persona platform 100 may import user instructions, user interaction data, user experience data, environmental data, and customer specific information and perform analysis of the data under the direction of the design factory 104 requirements to create an optimized experience with which to update the UX 102 as people interact with the user-facing portion of the UX 102. The user facing portion of the UX 102 may take the form of a holographic display unit 108, an augmented reality display implementation 110, a virtual reality display implementation 112, a display optimized for a mobile device 114, or any future display and interaction system that may be developed for such interactions between the digital persona platform and human users 116.

In an embodiment, normalization of data to a native data format maintained by the digital persona platform 100 creates a “universal translator” in that the algorithms, once applied, demonstrates that all parameters currently defined in the personality profile may be translated into the native data format. This personality profile is generated by the personality engine 120 component of the digital persona platform 100, as previously described. The personality profile may be also formatted for transmission to Internet of Things (IoT) 122 implementations and devices, or enterprise systems 124 for use in display systems and devices utilized in homes and business enterprises alike. The digital persona platform 100 thus enables the creation of fully formed CGCs and character scenes that may be presented in many display formats to facilitate the communication between human users and the display system, creating an improved user experience and optimizing communication and the transfer of information between human users and the display and communication system in which the digital persona platform 100 is integrated.

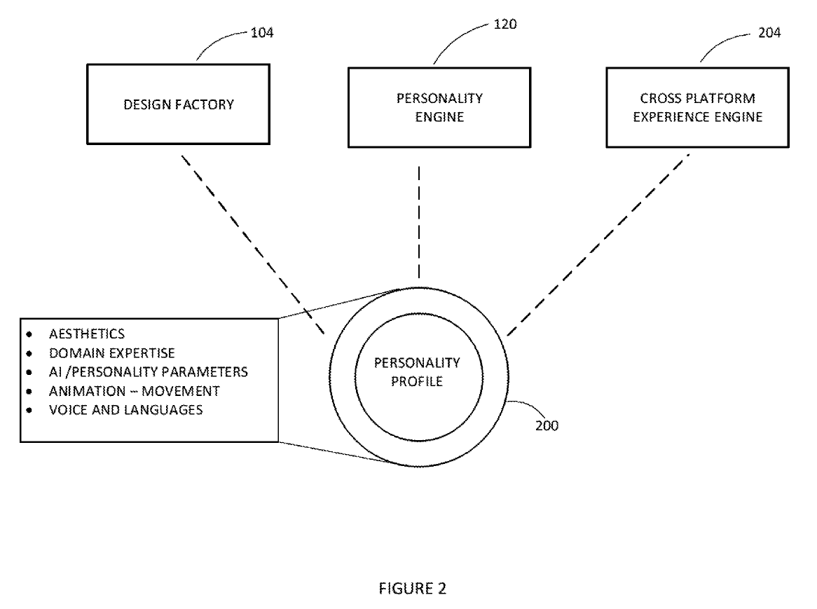

Turning now to FIG. 2, this figure presents a view of functions incorporated within and controlled by the personality profile platform component consistent with certain embodiments of the present invention. In an exemplary embodiment, the personality profile 200 component accepts input from system users, external data sources, and environmental information to create the base foundation of a personality that is then stored as a profile for a particular character or persona that may be utilized to animate a CGC when interacting with users in the UX. The personality profile 200, as previously disclosed, may include information for a CGC that includes aesthetic information (hair color and other physical characteristics, in a non-limiting example), AI and/or personality parameters, animation and movement information, as well as information about the voice to be assigned to the CGC and any languages, including motion-based languages, that the CGC may use to communicate with users.

The personality profile may also contain domain expertise information, which is a general term used to describe and store “what the personality knows about”. Through complex AI integrations, the digital persona platform may define the knowledge that supports a base context for a digital personality giving it context for formulating responses that are consistent with the CGC. In one or more non-limiting examples, the domain expertise information may consist of extensive medical information if the digital persona platform is deployed as a digital personality in a patient discharge module, or extensive knowledge of cell phone plan offerings if a digital personality is deployed as a cellular service sales rep.

The personality profile 200 may be configured to interact, either as an input or in accepting updated information, with other components of the digital persona platform. In a non-limiting example the personality profile 200 may receive instructions from the design factory 104 component of the digital persona platform to create new aspects to a personality based upon updated information from interactions with humans through the UX. The design factory 104 permits a user to add, update, delete, or otherwise manipulate the parameters and base information for a personality and how the personality interacts through the UX with one or more users. The design factory 104 also provides the ability to update one or more personalities for use and interaction with other users, or the personality may be exported as part of a digital scene to a system exterior to the system in which the personality was originally created, updated, modified and stored.

In an embodiment, the personality profile 200 may also accept information from the personality engine 120 to add, update, modify, and/or delete the appropriate response actions between a CGC and users of the system. This capability includes what the persona, as an expression of the personality, will say, how the persona will say it, and in what language and with what support actions (facial animation, secondary animation or even triggering other content from other systems) the persona is enabled. The information received from the personality engine 120 will be incorporated into the persona as an addition to the personality profile being built for the persona, and stored with the persona in the digital persona platform. As previously described, the updated persona created or modified by the personality profile 200 may be stored for use in interactions with users, or may be exported as part of a digital scene to an exterior system.

In an embodiment, the personality profile 200 may also interact with the cross platform experience engine 204 is built to provide cross-platform support so that the cross platform experience engine 204 may take the responses generated from the personality platform 200 and play them back as appropriate for the device upon which the persona is being displayed and interacting with users. The cross platform experience engine 204 permits the digital persona platform to expand deployment of one or more personas and/or personality information to additional display and interaction channels without impacting the digital personality 200 created by the digital persona platform.

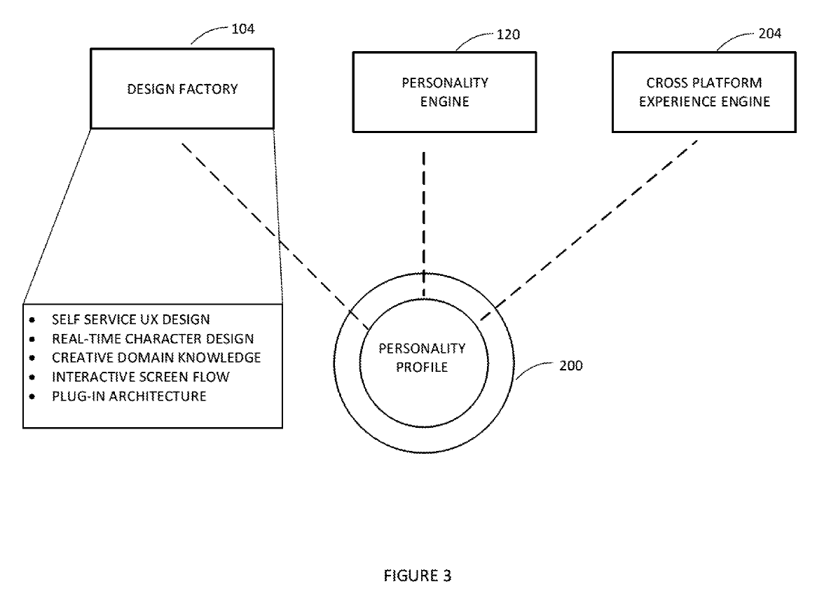

Turning now to FIG. 3, this figure presents a view of functions incorporated within and controlled by the design factory platform component consistent with certain embodiments of the present invention. In an embodiment, the specific elements of the design factory 104 platform component may include a real-time character design capability. This capability may permit the user to define and create the specific cosmetics, movements, voices, facial features, coloration, and all other aspects of the creation of a fully realized CGC. The design factory 104 component permits the user to control all of the elements of the personality profile 200 as defined and stored within the personality profile data. The user may also be able to define the specific domain expertise related to a product, service or brand to be served by the user-defined CGC. As additional capabilities such as artificial intelligence, text-to-speech, touch screen interactions, etc. are included in the development of the digital persona platform, brand or client domain expertise may allow one or more created characters to delivery responses appropriate to the self-service application for which the characters are designed to serve. In a non-limiting example, for the Toyota RAV 4 launch, the platform utilized a customized, rule-based artificial intelligence component. This artificial intelligence component was informed and trained such that when users requested information about the engine in the RAV4, the digital persona platform had that specific experience and knowledge to deliver details about the engine and drivetrain of the RAV4. The data format of the domain expertise will be appropriate to the artificial intelligence engines deployed with the platform. The artificial intelligence engines deployed with future updates to the digital persona platform may change to reflect improvements in the rules, processing, training, or other aspects of an artificial intelligence engine.

In an embodiment, the design factory 104 component may allow the user to define the screen flow for interaction with the UX. The screen flow refers to how the screens presented on a display interact with the user and the responses that will be triggered from the digital persona platform when the user interacts with various display screens. Additionally, the digital persona platform provides an architecture to permit the creation and addition of a plurality of plug-ins to expand the capabilities of the design factory 104 and the personality profile 200 as improvements to each portion of the digital persona platform are created and implemented.

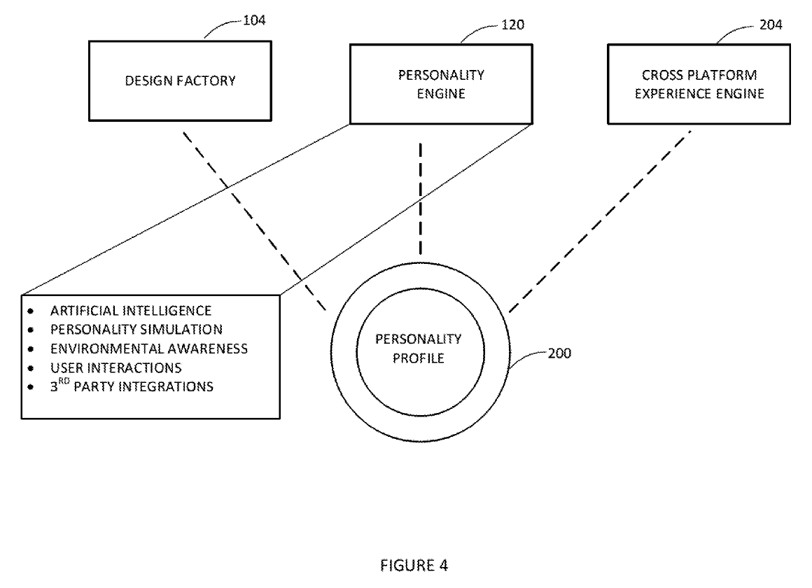

Turning now to FIG. 4, this figure presents a view of functions incorporated within and controlled by the personality engine platform component consistent with certain embodiments of the present invention. In a non-limiting example, the personality profile 200 may include data such as personality parameters as created, updated or modified by the personality engine 120. The personality parameter data may be centered around artificial intelligence and defining how a digital personality responds to situations, based upon initial rule set generation, personality training, and/or situational learning and improvement through complex AI interactions. However, importing the personality profile data that has been enhanced by AI interactions involves creating a language around cognitive services and how to define a digital personality itself. In a non-limiting example, the language to identify and define components of a digital personality is embedded within the digital persona platform and permits users to utilize the embedded language to create the components through user interaction utilizing an iterative process. If the personality is defined as “bubbly and fun”, it would formulate a different response than a personality defined as “business like and conservative”.

In a non-limiting example, the personality profile may also contain movement data that describes the constraints on movement by the personality when executed. The movement data may be a combination of animation produced from traditional over-the-counter 3D animation packages and/or motion capture facilities, but more importantly, the digital persona platform may utilize advanced AI development for creating algorithmically driven animation with regard to movement and updates to movement as the digital persona platform updates the movement data through operational experience and through input from users. Non-limiting examples may include eye movements where some personalities having more eye movement may be considered a “shifty” type personality of the eyes, where others may be prone to starting at major objects in the scene, while other may just stare off to space. Other items that may be algorithmically programmed include hand movements, head movement, torso movement, clothing movement, or any other movement that enhances the realism of the displayed personality.

In a non-limiting example, the personality profile may also contain voice/language data. Voice/Language data may include what languages the personality already understands and/or speaks, as well as the tonal quality and specific recognizable voice, just like humans will have. Current implementations utilize voice-over actors for a more natural delivery. Future implementations will replace voice-over data with synthesized voices as they become more natural. In a non-limiting example, the personality engine 120 may interact with a human user to create the basic simulation, movement, and user interactions required for a personality or a persona. The persona thus created is then displayed on one or more display devices to interact with one or more users. The user who created the persona may then update the personality data through the input mechanism associated with the personality engine 120 and utilizing the language embedded within the digital persona platform to modify and update the persona or personality user interactions to create an optimized personality or persona based upon such user interactions. Additionally, the personality engine 120 may interact with digital scenes and personality profiles to add personality data collected from third party integrations, thus permitted the import of multiple personas or personalities created in locations or systems exterior to the digital persona platform. These imported personalities or personas may be fully integrated into the personality profile 200 through action of the personality engine 120 to harmonize and interweave the imported profiles into the personality profile data structures maintained and managed by the digital persona platform.

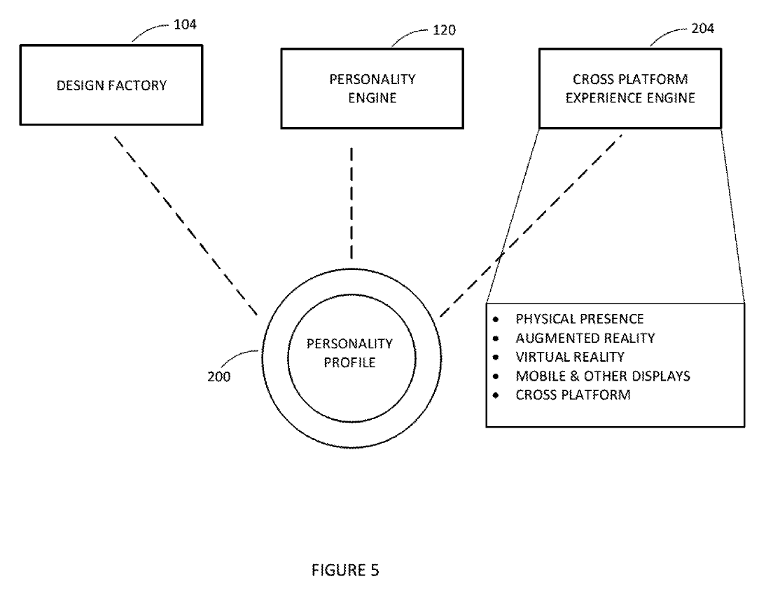

Turning now to FIG. 5, this figure presents a view of functions incorporated within and controlled by the experience engine cross-platform component consistent with certain embodiments of the present invention. In an embodiment, the experience engine 204 may take specific experiences as interpreted by the personality engine 200 and then may deploy that experience on the specific hardware or software platform being targeted. This cross-platform experience engine 204 may know specific performance characteristics of the platform such as, in non-limiting examples, “How is a click handled”, “What resolution and aspect ratio does the device support”, “What are the user interface elements that users can interact with”, “Is this an augmented reality, virtual reality or traditional playback”, “What type of camera control for the playback is required”. Simply put, the experience engine 204 contains a large amount of specific instance data on how the experience needs to “play back” to be appropriate for the platform. This module is key as the overall goal of the digital persona platform is to allow a single experience to be authorized at the global level and redistributed, within reasonable limits, on a large variety of hardware and software platforms without having to build custom experiences for each of those platforms. Additionally, the experience engine 204 may provide one or more user input screens, displays, or mechanisms to permit users on systems outside of the digital persona platform and third party data providers a mechanism for updating and optimizing personalities and personas that interact with users.

In an embodiment, the digital persona platform may comprise a plurality of characteristics that, when combined to create a CGC for display in a public environment, permit the display of and interaction with, a digital personality, not just a simple display of a pre-programmed character. The CGC displayed may appear to have a three-dimensional physical presence. Additionally, the CGC may be inserted into, and be a part of, an augmented reality environment, a virtual reality environment, and may be presented on mobile and other displays with cross platform support.

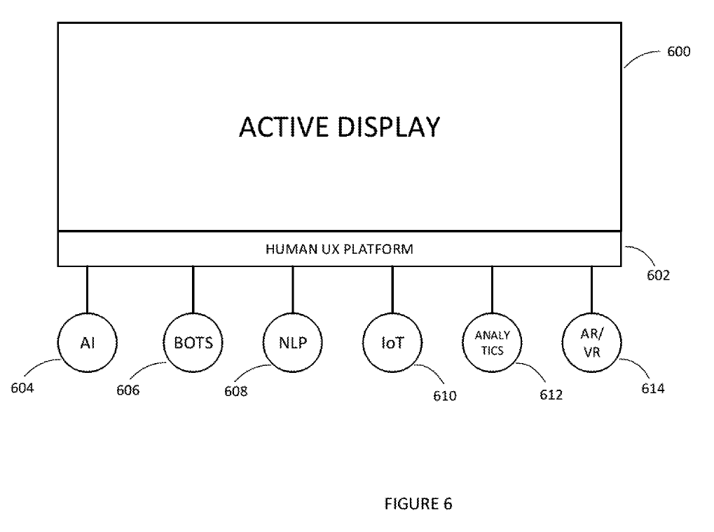

Turning now to FIG. 6, this figure presents a view of the human experience (UX) display platform component consistent with certain embodiments of the present invention. In an embodiment, an active display 600 is the presentation element for the digital persona platform, regardless of the device, display type or display enhancement employed to provide the optimum experience when interacting with users. The digital persona platform may deliver to the human UX platform component 602 personas, each having a particular personality associated with that persona, that may then be formatted for presentation on an active display 600.

In non-limiting examples, the human UX platform may create implementations and instances of personalities and personas for display on different display platforms. In these non-limiting examples, the human UX platform may format personalities, personas, and/or character scenes for display utilizing data from Artificial Intelligence systems 604, data gathered and presented by Bots 606, data created using Neuro Linguistic Programming 608, transmit data to and interact with systems connected through the Internet of Things 610, utilize data gleaned through the efforts of analytic engines 612, and/or providing interaction through Augmented or Virtual Reality systems 614. In each instance, the digital persona platform may create a personality, persona, or character scene that is readily transferable to one or more systems and present an optimized display capability and interaction with users regardless of the type of human UX associated with that system.

While certain illustrative embodiments have been described, it is evident that many alternatives, modifications, permutations and variations will become apparent to those skilled in the art in light of the foregoing description.

What is claimed is:

1. A system for implementing a digital persona platform, comprising:
a digital persona platform in data communication with at least one display device;
said platform instantiating a module for creating a computer-generated character for projection onto the display device;
said platform instantiating a module operative to receive as input parameters and data from which a personality is created for said computer-generated character;
said platform instantiating a module operative to store said personality data in a digital storage medium;
said platform instantiating a module to accept as input experience information and domain knowledge from one or more sources to create a design for the personality of said computer-generated character;
said platform instantiating a module operative to create and implement translation of personality data from a first display device to another display device;
said platform instantiating a module operative to create a plurality of interactive display scenes populated by said computer-generated character;
said platform instantiating one or more user interaction interfaces to accept active data and directions as user interaction information from said one or more user interaction interfaces as a user interacts with said interactive display scenes;
said platform storing received input data, user interaction information, and interactive display scenes in one or more character scene templates, where said character scene templates may be instantiated on said platform and/or exported to an external display system.

2. The system of claim 1, further comprising a display device permitting the display of computer-generated characters and/or character scenes formatted for any of mobile device information displays, augmented reality displays, virtual reality displays, holographic displays, and any combination of said display types.

3. The system of claim 1, where the platform may accept parameters, rules, and other information directly related to the operation, personality, and interaction with one or more computer-generated character personalities.

4. The system of claim 3, where the platform may present to a user, through said data communication channel, a user input mechanism to permit the direct input of user created parameters, rules, and other information.

5. The system of claim 3, where the platform is operative to collect indirect operational data as one or more users interact with one or more computer-generated characters presented on a display instantiated and managed by said platform, and where the platform updates one or more personalities with said indirect operational data collected during said user interaction.

6. The system of claim 1, where information included in a personality for a computer-generated character includes personality information, design information, interaction information, and cross-platform experience information.

7. The system of claim 6, where said computer-generated character personality information includes at least character aesthetic information, character domain expertise, animation and movement information, voice parameters, and language information.

8. The system of claim 6, where said computer-generated character design information includes at least character design information, creative domain knowledge, user interface design, interactive screen flow information, and character architecture information.

9. The system of claim 6, where said computer-generated character interaction information includes at least personality simulation information, environmental awareness information, user interaction information and artificial intelligence parameter information.

10. The system of claim 6, where said cross-platform experience information includes at least parameters and information to support interaction with display systems instantiated on augmented reality displays, virtual reality displays, mobile device displays, holographic displays, and support for multi-platform displays.

11. The system of claim 1, where user interaction comprises a user speaking with, responding to, or otherwise interacting with a displayed computer-generated character regardless of display system type.

12. The system of claim 1, where the character scene templates provide the information to create one or more character scenes, said character scenes being exported to one or more display systems, exterior server systems, or other interactive systems for display to and interaction with users.
